(19) United States
(12) Patent Application Publication
(10) Pub. No.: US 2017/0353625 A1
(43) Pub. Date: Dec. 7, 2017

(54) FAX AND PRINT METHOD AND FAX SYSTEM USING SAME

(71) Applicant: TECO IMAGE SYSTEMS CO., LTD., Taipei City (TW)

(72) Inventor: Ping-Tang Lu, Taipei City (TW)

(21) Appl. No.: 15/234,628

(22) Filed: Aug. 11, 2016

(30) Foreign Application Priority Data
Jun. 6, 2016 (TW) 105117889

(51) Int. Cl. H04N 1/44; H04M 7/12; H04N 1/00; H04W 4/14; H04B 1/3827

(52) U.S. Cl. CPC H04N 1/4413; H04N 1/444; H04M 7/123; H04N 1/00206; H04N 1/00312; H04B 1/3827; H04N 2201/006; H04N 2201/0094; H04W 4/14

(57) ABSTRACT

A fax and print method includes steps of providing a first fax device, a second fax device and a portable communication device, allowing the first fax device to send a fax password and a document to the second fax device and a data message and a text message corresponded to the fax password to the portable communication device, allowing the portable communication device to receive the text message and the data message, allowing the second fax device to receive the fax password and the document, generating a wireless connection between the portable communication device and the second fax device, judging if the text message is matched with the fax password, and printing the document when the result of the judgement is True. Therefore, the risk of being stolen is reduced through a transmission without the internet. The user does not have to remember any password. The user experiences are enhanced.

### CROSS-REFERENCE TO RELATED APPLICATION

This application claims priority from Taiwan Patent Application No. TW 105117889, filed on Jun. 6, 2016, the entire contents of which are incorporated herein by reference for all purposes.

### FIELD OF THE INVENTION

The present invention relates to a fax and print method, and more particularly to a fax and print method and a fax system using the same applied to a secret document.

### BACKGROUND OF THE INVENTION

Since the network is popularized, the risk of being stolen by a third party of E-mail and documents transferring or sharing via cloud is risen. The incidents of being stolen are frequently occurred. Especially, the documents accessed by a server is more dangerous. Considering the characteristics of the point-to-point transmission of the fax function, there is no need to transfer through a network server during transferring a secret document. That is, what is needed is only Public Switched Telephone Network (hereinafter “PSTN”) for transferring the secret document. The safety can be significantly enhanced and the risk of being stolen of the secret document can be reduced. It is the reason why the fax is usually selected for transferring a secret document.

However, after being received, the secret document is usually printed out by the fax machine, directly. The secret document will be held on the fax machine till the fax receiver gets the secret document. During the period, everyone who has chance to come close to the fax machine may take the secret document without any safety policy. It is the risk of the secret document being stolen by a third party. Under this circumstance, to avoid being stolen of the secret document and the information thereof, a conventional fax method of a secret document is utilized. Please refer to FIG. 1. FIG. 1 schematically illustrates the flow chart of a conventional fax method of a secret document of prior art. At first, the fax sender talks with the fax receiver via telephone, and requests the fax receiver to wait near the fax machine that is ready to receive a secret document as shown in step S11. Next, as shown in step S12, the fax receiver moves to the fax machine and waits for the beginning of the fax. Then, as shown in step S13, the fax receiver keeps waiting for the completion of the fax, and further takes the secret document away. The steps of the above-mentioned conventional fax method are complicated. As a result, the conventional fax method is inconvenient to both the fax sender and the fax receiver. It costs additional telephone fee and makes the time wasted for waiting the fax.

Therefore, there is a need of providing a fax and print method and a fax system using the same distinct from the prior art in order to solve the above drawbacks.

### SUMMARY OF THE INVENTION

Some embodiments of the present invention are to provide a fax and print method and a fax system using the same in order to overcome at least one of the above-mentioned drawbacks encountered by the prior arts.

The present invention provides a fax and print method and a fax system using the same. By allowing a first fax device to respectively send a fax password and a text message corresponded to the fax password to a second fax device and a portable communication device, generating a wireless connection between the portable communication device and the second fax device to judge if the text message is matched with the fax password, and further printing the document, a transmission can be implemented without internet, thereby reducing the risk of being stolen. Also, the user does not have to remember any password. That is, the user experiences of safety and convenience are simultaneously achieved.

The present invention also provides a fax and print method and a fax system using the same. Since the document and the corresponded password are stored in the second fax device, the portable communication device is used by a fax sender to wirelessly connect with the second fax device, and the document is printed out when the password matching is succeeded, the fax sender does not have to contact with a fax receiver, and the fax receiver does not have to wait around the second fax device. The time of both the fax sender and the fax receiver is effectively economized.

In accordance with an aspect of the present invention, there is provided a fax and print method. The fax and print method includes steps of providing a first fax device, a second fax device and a portable communication device, allowing the first fax device to send a fax password and a document to the second fax device and send a text message, which is corresponded to the fax password, and a data message to the portable communication device, allowing the portable communication device to receive the text message and the data message, allowing the second fax device to receive the fax password and the document, generating a wireless connection between the portable communication device and the second fax device, judging if the text message is matched with the fax password, and printing the document when the result of the judgement is True.

In accordance with another aspect of the present invention, there is provided a fax system. The fax system includes a first fax device, a portable communication device and a second fax device. The first fax device includes a first control unit, a password generator, a sending module and an input interface. The first control unit is connected with the password generator, the sending module and the input interface. The portable communication device includes a control module, a first receiving module, a first near field communication module and a first storage module. The control module is connected with the first receiving module, the first near field communication module and the first storage module. The second fax device includes a second control unit, a second receiving module, a second near field communication module, a second storage module and a print module. The second control unit is connected with the second receiving module, the second near field communication module, the second storage module and the print module. The fax and print method mentioned in the last paragraph is performed by the first fax device, the second fax device and the portable communication device.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the flow chart of a conventional fax method of a secret document of prior art;

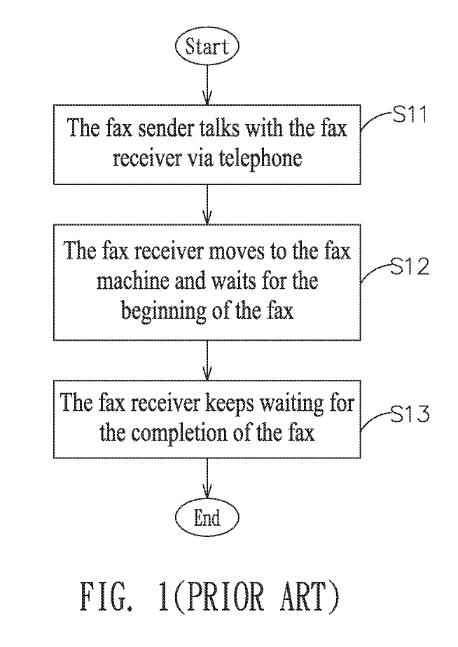

FIG. 2 schematically illustrates the structure of a fax system according to an embodiment of the present invention;

FIG. 3 schematically illustrates the flow chart of a fax and print method according to an embodiment of the present invention;

FIG. 4 schematically illustrates a detailed flow chart of the fax and print method according to an embodiment of the present invention;

FIG. 5 schematically illustrates a detailed flow chart of the fax and print method according to an embodiment of the present invention;

FIG. 6 schematically illustrates a detailed flow chart of the fax and print method according to an embodiment of the present invention;

FIG. 7 schematically illustrates the configuration of a first fax device of the fax system of the present invention;

FIG. 8 schematically illustrates the configuration of a second fax device of the fax system of the present invention; and

FIG. 9 schematically illustrates the configuration of a portable communication device of the fax system of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

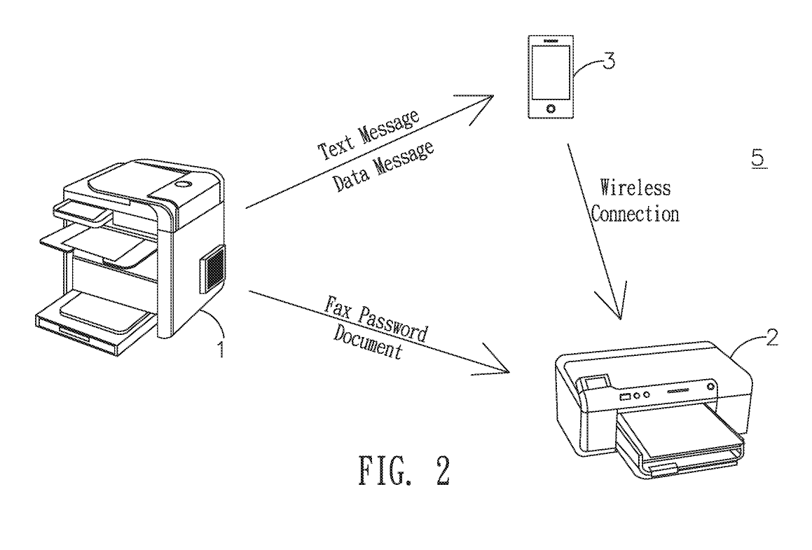

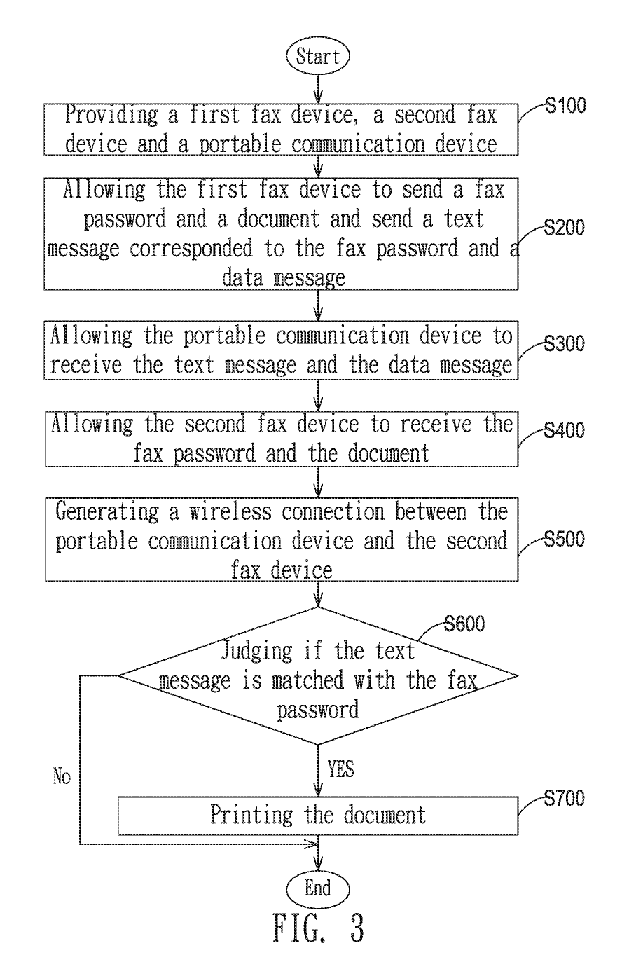

Please refer to FIG. 2 and FIG. 3. FIG. 2 schematically illustrates the structure of a fax system according to an embodiment of the present invention. FIG. 3 schematically illustrates the flow chart of a fax and print method according to an embodiment of the present invention. Please refer to FIG. 2 and FIG. 3, a fax and print method of the present invention is applied to a fax system 5. The fax and print method includes steps as follows. First of all, providing a first fax device 1, a second fax device 2 and a portable communication device 3 as shown in step S100. Next, allowing the first fax device 1 to send a fax password and a document to the second fax device 2 and send a text message, which is corresponded to the fax password, and a data message to the portable communication device 3. The text message includes a password message, and the password message is similar with the fax password or matched with the fax password. For example, the password message and the fax password can be the completely identical words, or words having specific meaning after combination, but not limited herein. The data message comprises a telephone number, a model information or a location information of the second fax device 2, so that a user can easily know how to obtain the document. Then, as shown in step S300 and step S400, allowing the portable communication device 3 to receive the text message and the data message and allowing the second fax device 2 to receive the fax password and the document.

In some embodiments, the sequence of the steps S300 and S400 can be adjusted. That is, the steps S300 and S400 can be simultaneously performed, or the step S300 can be performed before or after the step S400. Next, as shown in step S500, generating a wireless connection between the portable communication device 3 and the second fax device 2, then judging if the text message is matched with the fax password as shown in step S600, and printing the document when the result of the judgement is True as shown in step S700. In particular, the step S700 is performed by the second fax device 2. Therefore, a transmission can be implemented without internet, thereby reducing the risk of being stolen. Also, the user does not have to remember any password. That is, the user experiences of safety and convenience are simultaneously achieved. Moreover, the user may not know the exist of any password during implementing the fax and print method of the present invention. However, the safety level is apparently higher than remembering a password or waiting around the fax machine as in a conventional manner.

It is worth noting that in the fax and print method of the present invention, the text message and the data message are transmitted through PSTN by the first fax device 1 to the portable communication device 3. In other words, the transmission is implemented without the internet, thereby reducing the risk of being intercepted or stolen. In addition, the wireless connection between the second fax device 2 and the portable communication device 3 is preferably generated through the technology of Near Field Communication (i.e. NFC). Since NFC has characteristics of short-distance, fast connect speed and short reaction time, the demands of the fax and print method of the present invention are met.

In some embodiments, the first fax device 1 can be a normal fax machine or a multifunction printer, and the second fax device 2 is preferably a multifunction printer, but not limited herein. In general, a multifunction printer usually has the functions of a normal fax machine and has higher computing ability than the normal fax machine, so that the multifunction printer can handle the computing and document-handling that are more complicated. Under the configuration of the fax system 5 of the present invention, the step S600 of the fax and print method of the present invention is implemented by the second fax device 2, that is the reason why the second fax device 2 is preferably a multifunction printer.

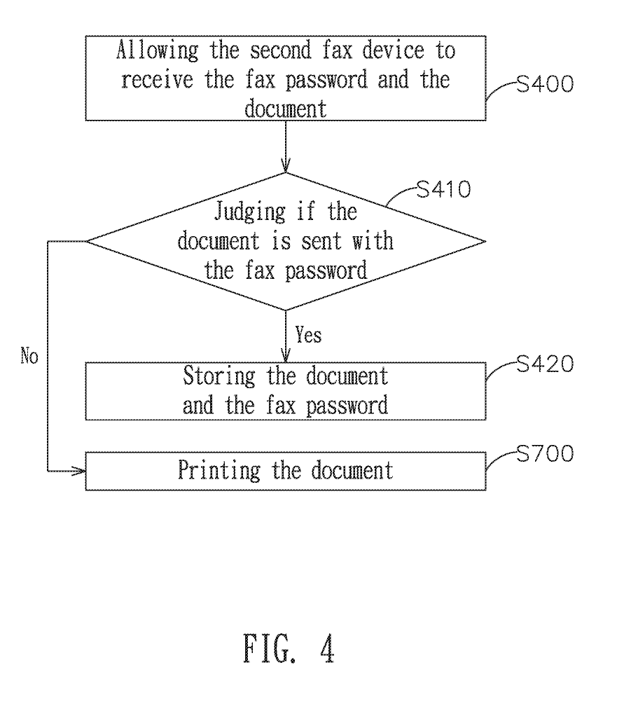

Please refer to FIG. 2 and FIG. 4. FIG. 4 schematically illustrates a detailed flow chart of the fax and print method according to an embodiment of the present invention. As shown in FIG. 2 and FIG. 4, the fax and print method of the present invention includes steps, after the step S400, of judging if the document is sent with the fax password as shown in step S410. In other words, the step S410 is a step of judging if the document and the fax password are simultaneously received, and the step S410 is preferred to be performed by the second fax device 2, but not limited herein. When the result of the judgement of the step S410 is True, a step S420 of storing the document and the fax password is performed after the step S410. Otherwise, when the result of the judgement of the step S410 is False, the step S700 of printing the document is performed after the step S410. That is, if the second fax device 2 judges that the document is not received with a fax password, the document is not a secret document, so that the document can be printed out directly.

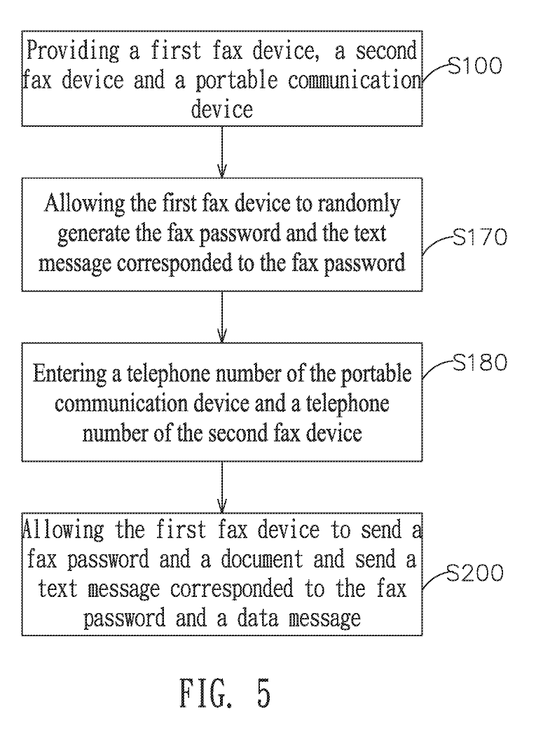

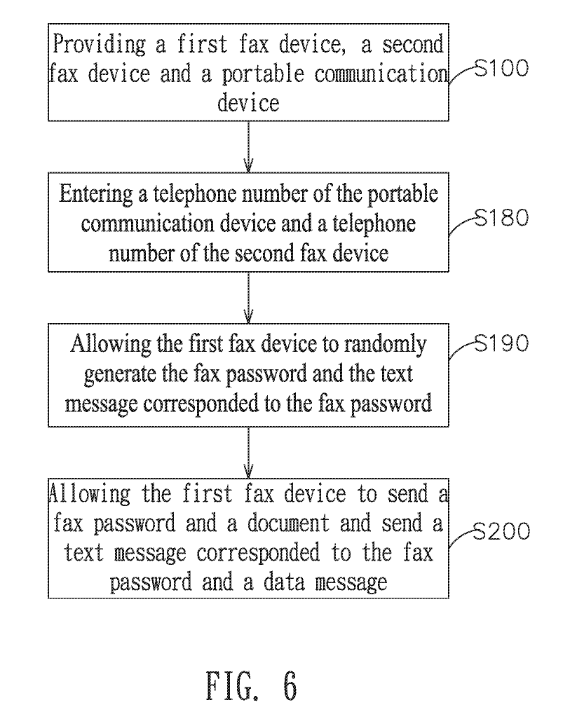

Please refer to FIG. 2, FIG. 5 and FIG. 6. FIG. 5 schematically illustrates a detailed flow chart of the fax and print method according to an embodiment of the present invention. FIG. 6 schematically illustrates a detailed flow chart of the fax and print method according to an embodiment of the present invention. As shown in FIGS. 2, 5 and 6, in an embodiment, the fax and print method of the present invention includes a step S180, before the step S200, of entering a telephone number of the portable communication device 3 and a telephone number of the second fax device 2 (i.e. a dial action of a user). Furthermore, the fax and print method of the present invention may include a step, before the step S180 or between the step S180 and the step S200, of allowing the first fax device 1 to randomly generate the fax password and the text message corresponded to the fax password as shown in step S170 in FIG. 5 and as shown in step S190 in FIG. 6.

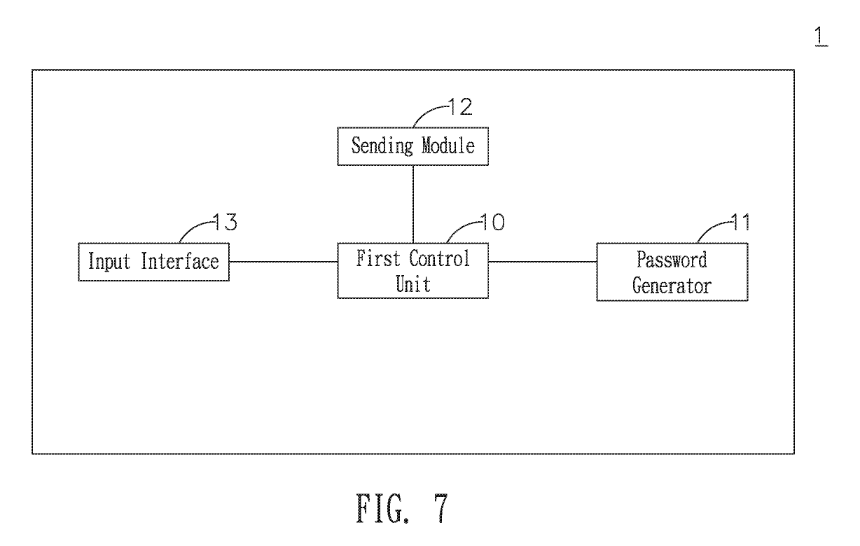

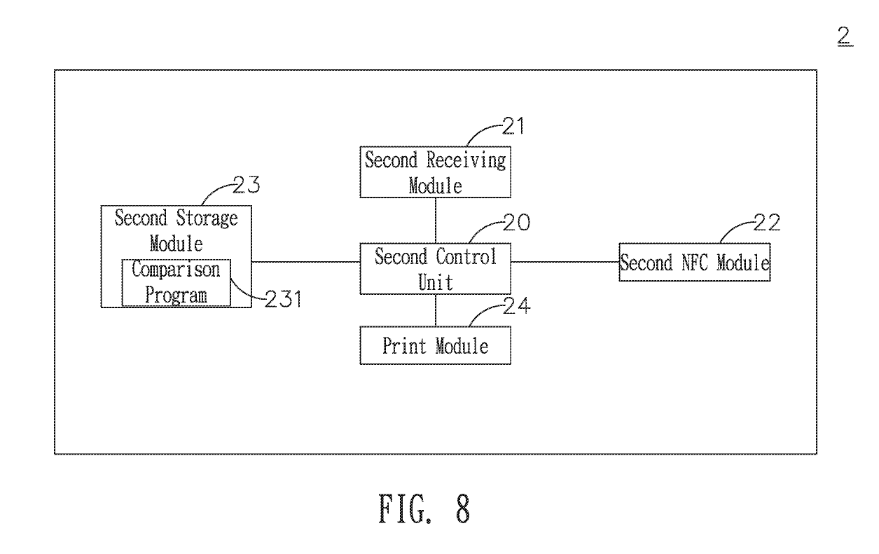

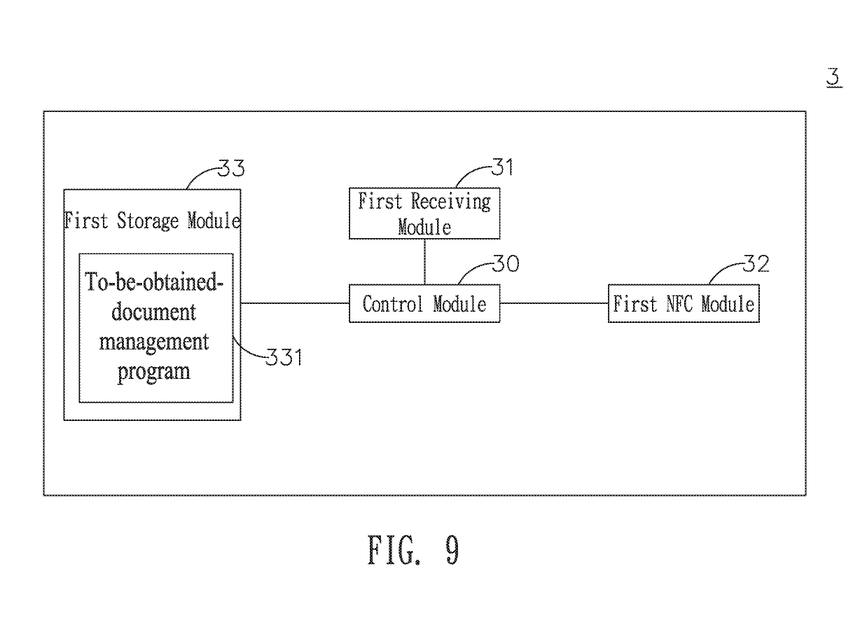

Please refer to FIGS. 2, 7, 8 and 9. FIG. 7 schematically illustrates the configuration of a first fax device of the fax system of the present invention. FIG. 8 schematically illustrates the configuration of a second fax device of the fax system of the present invention. FIG. 9 schematically illustrates the configuration of a portable communication device of the fax system of the present invention. As shown in FIG. 2, FIG. 7, FIG. 8 and FIG. 9, a fax system 5 of the present invention includes a first fax device 1, a second fax device 2 and a portable communication device 3. An example of the portable communication device 3 includes a smart phone, a notebook PC or a tablet PC, but not limited thereto. The first fax device 1 includes a first control unit 10, a password generator 11, a sending module 12 and an input interface 13. The first control unit 10 is connected with the password generator 11, the sending module 12 and the input interface 13. The second fax device 2 includes a second control unit 20, a second receiving module 21, a second near field communication module 22, a second storage module 23 and a print module 24. The second control unit 20 is connected with the second receiving module 21, the second near field communication module 22, the second storage module 23 and the print module 24. The portable communication device 3 includes a control module 30, a first receiving module 31, a first near field communication module 32 and a first storage module 33. The control module 30 is connected with the first receiving module 31, the first near field communication module 32 and the first storage module 33. The fax and print method mentioned above and according to the embodiments of the present invention is preferred to be performed by the first fax device 1, the second fax device 2 and the portable communication device 3.

In particular, the password generator 11 of the first fax device 1 is utilized for generating the fax password and the text message. The step S170 or the step S190 of the fax and print method of the embodiments mentioned above is performed by the password generator 11. The sending module 12 of the first fax device 1 is utilized for sending the fax password and the document to the second fax device 2 and sending the text message corresponded to the fax password and the data message to the portable communication device 3. The input interface 13 of the first fax device 1 provides an interface for a user to input a telephone number, so that the user may execute the step S180 of the fax and print method of the embodiments mentioned above through the input interface 13.

The second receiving module 21 of the second fax device 2 is utilized for receiving the fax password and the document sent by the sending module 12. The second near field communication module 22 of the second fax device 2 is utilized for wirelessly connecting with the first near field communication module 32 of the portable communication device 3. The second storage module 23 of the second fax device 2 is utilized for storing a comparison program 231, the document and the fax password, but not limited thereto. When the second fax device 2 is going to perform the step S600 of the fax and print method of the embodiments mentioned above, the comparison program 231 is executed by the second control unit 20 of the second fax device 2 for comparing. The print module 24 of the second fax device 2 is utilized for printing (i.e. performing the step S700).

The first receiving module 31 of the portable communication device 3 is utilized for receiving the text message and the data message sent by the sending module 12. The first storage module 33 of the portable communication device 3 is utilized for storing a to-be-obtained-document management program 331, the text message and the data message, but not limited herein. The to-be-obtained-document management program 331 may be executed in the background of the operation system of the portable communication device 3. Preferably, the to-be-obtained-document management program 331 is executed by the control module 30. When the text message and the data message are received by the portable communication device 3, the to-be-obtained-document management program 331 reminds the user to obtain the document. Meanwhile, the to-be-obtained-document management program 331 can be utilized for managing the documents that are not practically obtained by the user.

From the above description, the present invention provides a fax and print method and a fax system using the same. By allowing a first fax device to respectively send a fax password and a text message corresponded to the fax password to a second fax device and a portable communication device, generating a wireless connection between the portable communication device and the second fax device to judge if the text message is matched with the fax password, and further printing the document, a transmission can be implemented without internet, thereby reducing the risk of being stolen. Also, the user does not have to remember any password. That is, the user experiences of safety and convenience are simultaneously achieved. Meanwhile, since the document and the corresponded password are stored in the second fax device, the portable communication device is used by a fax sender to wirelessly connect with the second fax device, and the document is printed out when the password matching is succeeded, the fax sender does not have to contact with a fax receiver, and the fax receiver does not have to wait around the second fax device. The time of both the fax sender and the fax receiver is effectively economized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A fax and print method, comprising steps of:
(a) providing a first fax device, a second fax device and a portable communication device;
(b) allowing the first fax device to send a fax password and a document to the second fax device and send a text message, which is corresponded to the fax password, and a data message to the portable communication device, wherein the text message and the data message is transmitted to the portable communication device through Public Switched Telephone Network by the first fax device;
(c) allowing the portable communication device to receive the text message and the data message;
(d) allowing the second fax device to receive the fax password and the document;
(e) generating a wireless connection between the portable communication device and the second fax device;
(f) judging if the text message is matched with the fax password; and
(g) printing the document,
wherein when the result of the judgement of the step (f) is True, the step (g) is performed after the step (f).

2. The fax and print method according to claim 1 further comprising steps, after the step (d), of:
(d1) judging if the document is sent with the fax password; and
(d2) storing the document and the fax password,
wherein when the result of the judgement of the step (d1) is True, the step (d2) is performed after the step (d1), and when the result of the judgement of the step (d1) is False, the step (g) is performed after the step (d1).

3. The fax and print method according to claim 1 further comprising a step, before the step (b), of (b0) entering a telephone number of the portable communication device and a telephone number of the second fax device.

4. The fax and print method according to claim 3 further comprising a step, before the step (b0) or between the step (b0) and the step (b), of (b1) allowing the first fax device to randomly generate the fax password and the text message corresponded to the fax password.

5. (canceled)

6. The fax and print method according to claim 1, wherein the wireless connection is generated through the technology of Near Field Communication.

7. The fax and print method according to claim 1, wherein the text message comprises a password message, and the password message is similar with the fax password or matched with the fax password.

8. The fax and print method according to claim 1, wherein the data message comprises a telephone number, a model information or a location information of the second fax device.

9. A fax system, comprising:
a first fax device comprising a first control unit, a password generator, a sending module and an input interface, wherein the first control unit is connected with the password generator, the sending module and the input interface;
a portable communication device comprising a control module, a first receiving module, a first near field communication module and a first storage module, wherein the control module is connected with the first receiving module, the first near field communication module and the first storage module; and
a second fax device comprising a second control unit, a second receiving module, a second near field communication module, a second storage module and a print module, wherein the second control unit is connected with the second receiving module, the second near field communication module, the second storage module and the print module,
wherein the fax and print method according to claim 1 is performed by the first fax device, the second fax device and the portable communication device.

10. The fax system according to claim 9, wherein the step (b) is performed by the first fax device, the step (d), the step (f) and the step (g) are performed by the second fax device, the step (c) is performed by the portable communication device, and the step (e) is performed by the portable communication device and the second fax device simultaneously.
